(19) United States
(12) Patent Application Publication
(10) Pub. No.: US 2023/0045548 A1
(43) Pub. Date: Feb. 9, 2023

(54) AUGMENTATION OF MULTIMODAL TIME SERIES DATA FOR TRAINING MACHINE-LEARNING MODELS

(71) Applicants: BASF SE, Ludwigshafen am Rhein (DE); TECHNISCHE UNIVERSITÄT BERLIN, Berlin (DE)

(72) Inventors: Nataliya Yakut, Ludwigshafen am Rhein (DE); Mihail Bogojeski, Berlin (DE); Klaus-Robert Mueller, Berlin (DE)

(21) Appl. No.: 17/793,728

(22) PCT Filed: Jan. 19, 2021
(86) PCT No.: PCT/EP2021/051039

§ 371 Date: Jul. 19, 2022

(30) Foreign Application Priority Data
Jan. 21, 2020 (EP) 20152801.5

(51) Int. Cl. G06N 3/04; G06N 3/08; G06N 3/063; G05B 13/04

(52) U.S. Cl. CPC G06N 3/0454; G06N 3/08; G06N 3/0445; G06N 3/063; G05B 13/048

(57) ABSTRACT

The present invention relates to training predictive data-driven model for predicting an industrial time dependent process. A data driven generative model is introduced for modelling and generating complex sequential data comprising multiple modalities, by learning a joint time-dependent representation of the different modalities. The model may be configured to handle any combination of missing modalities, which enables conditional generation based on known modalities, providing a high degree of control over the properties of the generated sequences.

### FIELD OF THE INVENTION

The present invention relates to training predictive data-driven model for predicting an industrial time dependent process. In particular, the present invention relates to a device and a method for generating synthetic samples for expanding a training dataset of a predictive data-driven model for predicting an industrial time dependent process, to an apparatus and a method for predicting an industrial time dependent process, as well as to a computer program product and to a computer readable medium.

### BACKGROUND OF THE INVENTION

Given current processing capability, it is now practical to implement complex neural networks to perform various tasks. For example, neural networks have been implemented in the accurate forecasting of time series, which is a vital part in the decision-making process across many industries, facilitating the optimization of many operational processes within a company. In recent years, recurrent neural network (RNN) models have emerged as the most successful methods for modelling sequential data in a wide range of applications.

Neural networks are configured through learning, which can be referred to as a training stage. In the training stage for modelling sequential data, training data is processed by the neural network. Thus, it is intended that the neural network learn how to perform forecasting of time series by generalizing the information it learns in the training stage from the training data.

One problem that can occur when training a particularly complex neural network, i.e., a neural network having a large number of parameters, is overfitting. Overfitting occurs when the neural network simply memorizes the training data that it is provided, rather than generalizing well to new examples. Generally, the overfitting problem is increasingly likely to occur as the complexity of the neural network increases.

Overfitting may be mitigated by providing the neural network with more training data. However, the collection of training data is a laborious and expensive task. For example, time series operation data from real-world industrial processes, e.g. chemical plant, load forecasting, battery discharge, may often be difficult to measure in large quantities and are very slow and expensive to produce, which poses a challenge for the training of data-hungry complex non-linear machine learning models such as RNNs. Furthermore, such processes may be often subject to gradual or sudden changes in the process dynamics, caused by often inevitable nonstationarities in the real-world environment. This may in turn lead to slight shifts in the distribution underlying the time series data collected from the process, leading to further problems when trying to use standard machine learning models for long-term forecasting. Finally, the expenses and difficulties involved in the gathering and processing of new real-world data may often make it impossible to quickly obtain new data, which may prohibit the effective implementation of the various successful covariate shift and domain adaptation strategies.

### SUMMARY OF THE INVENTION

There may be a need to improve training of a predictive data-driven model for predicting an industrial time dependent process.

The object of the present invention is solved by the subject-matter of the independent claims, wherein further embodiments are incorporated in the dependent claims. It should be noted that the following described aspects of the invention apply also for the device and the method for generating synthetic samples for expanding a training dataset of a predictive data-driven model for predicting an industrial time dependent process, the apparatus and the method for predicting an industrial time dependent process, the computer program product, and the computer readable medium.

According to a first aspect of the present invention, there is provided a device for generating synthetic samples for expanding a training dataset of a predictive data-driven model for predicting an industrial time dependent process. The device comprises an input unit, a processing unit, and an output unit. The input unit is configured to receive historical data of at least one condition parameter indicative of a condition under which the industrial time dependent process took place and at least one KPI provided for quantifying the industrial time dependent process. The processing unit is configured to apply a data-driven generative model to derive synthetic samples of the at least one condition parameter and the at least one KPI from the historical data. The data-driven generative model is parametrized or trained based on a training dataset comprising real-data examples of the at least one condition parameter and the at least one KPI. The output unit is configured to provide the synthetic samples to the training dataset of the predictive data-driven model.

In other words, a data-driven generative model is proposed to model and generate complex sequential data with multiple modalities by learning a joint time-dependent representation of the different modalities. Instead of generating real-valued time series, the data-driven generative model is used to explore the aspects of data augmentation, where the data-driven generative model learns the joint time-dependent representation of different modalities and tries to generate similar data samples representing new synthetic training data to expand the training dataset of the predictive data-driven model for predicting an industrial time dependent process. Using generative models trained on the training set, new samples can be generated from the training distribution and augment the training dataset of the predictive data-driven model using these samples. In some examples, some measure of control may be applied over the properties of samples that are being generated in order to guide the generated samples depending on the task requirements, and thus increase the span of the training set when we augment it with these generated samples. With more training data (i.e. synthetic training data in addition to the historical real-world data), overfilling may be mitigated. Thus, the predictive data-driven model for predicting an industrial time dependent process may generalize well to new examples instead of simply memorizing the training data that it is provided. The data augmentation may be beneficial for increasing the model generalization and thus for reducing errors in scenarios where little real-world data is available. The increased span of the training set may be also beneficial for bridging the gap between the training and test sets, thereby improving the generalization performance of the model.

The data-driven generative model is configured to reproduce a relation between at least two modalities: at least one condition parameter and at least one KPI. Different modalities are characterized by different statistical properties. Due to the distinct statistical properties of the at least one condition parameter and the at least one KPI, it is very important to discover the relationship between the at least two different modalities. The data-driven generative model may be used to represent the joint representations of different modalities. Optionally, the data-driven generative model may be capable to fill missing modality given the observed ones.

In some examples, the generative model may be configured to reproduce the relation between exactly two modalities, i.e. one condition parameter (e.g. temperature) and one KPI.

In some examples, the generative model may be configured to reproduce the relation between more than two modalities. For example, one or more condition parameters (e.g. temperature, pressure, and flow rate) may be aggregated in a first modality. Raw material quality, which may be represented by multiple variables, may be aggregated in a second modality. The third modality may be one KPI.

In some cases, more than two KPIs may be used for quantifying the industrial time dependent process. In such cases, the multiple KPIs are not aggregated in one modality. Rather, each KPI may be represented as a separate modality. For example, two KPIs may be represented as two different modalities, and three KPIs may be represented as three different modalities.

The data-driven generative model is also used to reproduce a time-dependent relation between the at least two modalities. For example, the data-driven generative model may attempt to produce time series that very closely resemble the operating parameters and KPIs given as input, with only small differences caused by the random sampling of the latent variable from the joint posterior. In this way, it is possible to produce enough time series operation data for the training of data-hungry complex non-linear machine learning models such as RNNs.

Unlike existing generative models capable of generating time series for classification problems (e.g., Chung et. al., 2015) or generative models capable of generating multimodal data for classification problems (e.g., Wu and Goodman, 2018), the proposed data driven generative model is used to generate multimodal time series not only for classification but also for regression problems. The data driven generative model may also offer a measure of control over the generated samples by enabling generation based on the unconditioned joint posterior distribution over all modalities, or based on the conditional distribution of any subset of modalities.

The data driven generative model is parametrized or trained based on historical data. The data driven generative model may include a latent variable generative model, e.g. multimodal variational autoencoders (MVAEs). A latent representation, i.e. compressed feature vector, is generated with the help of neural networks suitable for handling time series. For example, RNNs may be used for generating the latent representation. Then, the latent representation is used to generate synthetic data by use of the data-driven generative model.

The synthetic data of both modalities, i.e. the at least one condition parameter and the at least one KPI, may be generated by sampling in various ways. In the first case, the synthetic data may be generated from the prior distribution with no modalities as input. The resulting synthetic data set will be a completely independent one, where the functional relationship between the operating parameters and KPIs is maintained. In the second case, the synthetic data may be generated from the posterior conditioned on the operating parameters. The generated operating conditions should closely resemble the operating parameters used as input/conditioning, and the generative model will try to generate the KPI(s) that are still properly functionally related to the operating parameters used as input. This also applies to the third case, where the synthetic data are generated from the posterior conditioned on the at least one KPI. In the fourth case, the synthetic data may be generated from the posterior conditioned on the operating parameter(s) and the KPI(s). The generative model will attempt to produce time series that very closely resemble the operating parameters and KPIs given as input, with only small differences caused by the random sampling of the latent variable from the joint posterior.

Modalities having missing values may be generatively filled, for example using trained data driven generative models, such as by sampling from the conditional distributions over the missing modality given input values. The input values may be for another modality and/or for elements of the same modality as the modality of the missing values. In some examples, the data driven generative model may use input values for fewer modalities of data than the number of modalities used to train the generative model.

In some examples, conditioning the data driven generative model with existing operating parameters or KPIs may be used to guide the generated samples depending on the task requirements. Accordingly, synthetic training data may be created to simulate not yet or less encountered conditions, thereby overcoming real data usage restrictions. Conditioning the data driven generative model may be beneficial for process industries, where the process parameters are tightly fit. For example, if we want to train the model with data where the condition parameters have extreme values, this may be very difficult to do with real data since running the reactor in this regime can be very expensive and unproductive and may even damage the plant. Instead, we would feed our generative model these extreme values and obtain generated KPIs that would simulate what happens in the reactor in these conditions.

Similarly, if we want to train our model for a particular type of KPI cycle (e.g optimal or suboptimal production), one could give these types of KPI cycles to the generative model to generate the corresponding operating parameters.

The historical data may also be referred to as real-world data. For example, the historical data may include data collected from similar or same types of chemical substance, component, equipment, and/or system in multiple production runs and/or multiple plants. Including multiple production runs into the training may allow to cover different operating conditions of the same or different plant(s).

In some examples, the condition may include operating conditions, such as pressure, temperature, flow rates, and humidity of reactant gases of a chemical process equipment. The condition parameter may include operating parameters, i.e. a quantity indicative of the operation status. For example, such quantities may relate to measurement data collected e.g. during the production run of a chemical production plant and may be directly or indirectly derived from such measurement data. For example, the measurement data may include sensor data measured through sensors installed in the chemical production plant, quantities directly or indirectly derived from such sensor data. Sensor data may include measured quantities available in chemical production plants by means of installed sensors, e.g., temperature sensors, pressure sensors, flow rate sensors, etc. In some examples, the condition may include storage conditions, such as storage temperature of an enzyme.

The industrial time dependent process may have one or more KPIs for quantifying the industrial time dependent process. The one or more KPIs may represent one or more modalities in the data-driven generative model. The one or more KPIs may be selected from parameters comprising: a parameter contained in a set of measured process and/or storage condition data and/or a derived parameter representing a function of one or more parameters contained in a set of the measured process and/or storage condition data. In other words, the one or more KPIs may comprise parameters that are measured directly using a sensor, e.g., a temperature sensor or a pressure sensor. The one or more KPIs may alternatively or additionally comprise parameters that are obtained indirectly through proxy variables. For example, while catalyst activity is not measured directly in process data, it manifests itself in reduced yield and/or conversion of the process. The one or more KPIs may be defined by a user (e.g. process operator) or by a statistical model e.g. an anomaly score measuring the distance to the “healthy” state of the equipment in a multivariate space of relevant process and/or storage condition data, such as the Hotelling T² score or the DModX distance derived from principal component analysis (PCA). Here, the healthy state may refer to the bulk of states that are typically observed during periods in the historic process and/or storage condition data that were labelled as “usual”/“unproblematic”/“good” by an expert for the production process.

In some examples, prediction of an industrial time dependent process may be used to identify whether a chemical substance, a component, an equipment, and/or a system is deviating from or will deviate from its typical behavior. In some examples, prediction of an industrial time dependent process may be used to identify the off-the-shelf performance of a chemical substance, a component, an equipment, and/or a system.

According to an embodiment of the present invention, the synthetic samples comprise a synthetic sequence representative of a time series of the at least one condition parameter and the at least one KPI.

A latent representation, i.e. compressed feature vector, may be generated with the help of neural networks (e.g., RNNs) suitable for handling time series.

According to an embodiment of the present invention, the data-driven generative model comprises an RNN-MVAE model with the at least one condition parameter and the at least one KPI as input and a synthetic sequence of the at least one condition parameter and the at least one KPI as output. The RNN-MVAE model comprises a multimodal variational autoencoder (MVAE). The MVAE comprises two recurrent neural networks (RNNs) that act as an encoder-decoder pair for the at least one condition parameter. The MVAE comprises two RNNs that act as an encoder-decoder pair for the at least one KPI.

In other words, the RNN-MVAE model is an MVAE model that uses RNNs as the encoder and decoder networks for the sequential modalities, producing a single joint posterior for the entire sequences of all modalities.

RNNs have a hidden state, or “memory”, allowing them to memorize important signature of the input signals which only affect the output at later time.

According to an embodiment of the present invention, the data-driven generative model comprises a Seq-MVAE model with the at least one condition parameter and the at least one KPI as an initial input and a synthetic sample of the at least one condition parameter and the at least one KPI as output. The Seq-MVAE model comprises a multimodal variational autoencoder (MVAE). The MVAE comprises two feed forward neural networks (FFNNs) that act as an encoder-decoder pair for the at least one condition parameter. The MVAE comprises two feed forward neural networks (FFNNs) that act as an encoder-decoder pair for the at least one KPI. Each decoder and encoder are coupled to a respective recurrent neural network (RNN). For each point in time the output of the Seq-MVAE is aggregated into a vector representative of the synthetic sequence.

In other words, the Seq-MVAE model uses the basic MVAE architecture to generate individual multimodal time samples once at a time, while using RNNs to maintain the temporal context and dependence across samples generated at different time points within each sequence.

The Seq-MVAE may easily incorporate non-sequential modalities, simply by repeatedly proving them as a present modality after a number of time steps, each time step or at the beginning of the time sequence. Another advantage of the Seq-MVAE may be the model's ability to sample from the joint posterior distribution conditioned on any combination of modalities. This may enable to condition the model's posterior based on any provided modalities regardless of whether they are sequential or non-sequential, giving a great degree of control over the properties of the multimodal sequences to generate for data augmentation, as well as making the model capable of missing values imputation.

According to an embodiment of the present invention, the RNN comprises at least one of: an echo state network (ESN), a gated recurrent unit (GRU) network, an ordinary differential equation (ODE) network, and a long short-term memory (LSTM) network.

For example, ESNs use very large randomly initialized weight matrices, which essentially act as a random feature expansion of the input, combined with a recurrent mapping of the past inputs; collectively called the “reservoir”. Since the only learned parameters are the weights of the linear model used for the final prediction, ESNs can be trained on smaller datasets without risking too much overfitting.

Another exemplary architecture for dealing with the vanishing gradients problem in RNNs is the long short-term memory (LSTM) architecture. LSTMs are trained using error backpropagation as usual, but avoid the problem of vanishing gradients by using an additional state vector called the “cell state”, alongside the usual hidden state. Due to the multiple layers needed to model the gates that regulate the cell state, the LSTM may require larger amounts of training data to avoid overfitting. Though despite its complexity, the stability of the gradients of the LSTM make it very well suited for time series problems with long-term dependencies.

According to a second aspect of the present invention, there is provided an apparatus for predicting an industrial time dependent process. The apparatus comprises an input unit, a processing unit, and an output unit. The input unit is configured to receive currently measured data indicative of a current condition under which the industrial time dependent process currently takes place. At least one key performance indicator (KPI) is provided for quantifying the industrial time dependent process. The input unit is configured to receive at least one expected condition parameter indicative of a future condition under which the industrial time dependent process will take place within a prediction horizon. The processing unit is configured to apply a predictive data-driven model to an input dataset comprising the currently measured data and the at least one expected condition parameter to estimate a future value of the at least one KPI within the prediction horizon, wherein the predictive data-driven model is parametrized or trained according to a training dataset comprising historical data of the at least one condition parameter and the at least one KPI and synthetic samples of the at least one condition parameter and the at least one KPI. The output unit is configured to provide a prediction of the future value of at least one KPI within the prediction horizon, which is usable for monitoring and/or controlling the industrial time dependent process.

The synthetic samples refer to synthetic data that is artificially created rather than being generated by actual events. The synthetic samples can replicate important statistical properties of the historical real-world data without exposing real data. One method for building the synthetic samples may be drawing numbers from a distribution. This method works by observing real statistic distributions and reproducing synthetic data. This method may also include the creation of generative models, which may be established using historical real data. An example of the generative models is the generative data-driven model as described above and below.

Optionally, the synthetic samples may be provided by a device according to the first aspect and any associated example.

In other words, prediction of an industrial time dependent process may be used to identify to what extent a chemical substance, a component, an equipment, and/or a system will deviate from its typical behavior in the future based on a sequence of known conditions. An example is the prediction of an industrial aging process, which is effect whereby a component, such as a battery, or a chemical process equipment, suffers some form of material deterioration with an increasing likelihood of failure over the lifetime. Ageing equipment is equipment for which there is evidence or likelihood of significant deterioration and damage taking place since new, or for which there is insufficient information and knowledge available to know the extent to which this possibility exists. The significance of deterioration and damage relates to the potential effect on the equipment's functionality, availability, reliability and safety. Just because an item of equipment is old does not necessarily mean that it is significantly deteriorating and damaged. All types of equipment may be susceptible to ageing mechanisms. Examples of aging mechanisms may include corrosion, erosion, fatigue, embrittlement, weathering, expansion/contraction due to temperature changes (process or ambient) or freezing, detector poisoning, subsidence. Overall, aging plant (or equipment or chemical substance) is a plant (or equipment or chemical substance) which is, or may be, no longer considered fully fit for purpose due to deterioration or obsolescence in its integrity or functional performance. ‘Aging’ is not directly related to chronological age. There are many examples of very old plant remaining fully fit for purpose, and of recent plant showing evidence of accelerated or early ageing, e.g. due to corrosion, fatigue or erosion failures.

With more training data, including synthetic training data and historical real-world data, overfilling can be mitigated. Thus, the predictive data-driven model for predicting an industrial time dependent process may generalize well to new examples instead of simply memorizing the training data that it is provided. The data augmentation may be beneficial for increasing the model generalization and thus for reducing errors in scenarios where little real-world data is available. This may also increase span of the training set can help us bridge the gap between the training and test sets and thus improve the generalization performance of the model.

According to a third aspect of the present invention, there is provided an apparatus for predicting an industrial time dependent process. The apparatus comprises an input unit, a processing unit, and an output unit. The input unit is configured to receive previously measured data indicative of a past condition under which the industrial time dependent process took place, wherein at least one key performance indicator (KPI) is provided for quantifying the industrial time dependent process. The input unit is configured to receive at least one condition parameter indicative of a current condition under which the industrial time dependent process currently takes place. The processing unit is configured to apply a predictive data-driven model to an input dataset comprising the previously measured data and the at least one condition parameter to estimate a current value of the at least one KPI, wherein the predictive data-driven model is parametrized or trained according to a training dataset comprising historical data of the at least one condition parameter the at least one KPI and synthetic samples of the at least one condition parameter and the at least one KPI provided. The output unit is configured to provide a prediction of the current value of at least one KPI which is usable for monitoring and/or controlling the industrial time dependent process.

Optionally, the synthetic samples may be provided by a device according to the first aspect and any associated example. In other words, prediction of an industrial time dependent process may be used to identify the current performance (e.g., off-the-shelf performance) of a chemical substance, a component, an equipment, and/or a system. Further examples may include the prediction of shelf-life performance of an enzyme, i.e. whether an enzyme loses its activity under a particular storage condition for a period of time.

Similarly, with more training data, including synthetic training data and historical real-world data, overfilling can be mitigated. Thus, the predictive data-driven model for predicting an industrial time dependent process may generalize well to new examples instead of simply memorizing the training data that it is provided. The data augmentation may be beneficial for increasing the model generalization and thus for reducing errors in scenarios where little real-world data is available. This may also increase span of the training set can help us bridge the gap between the training and test sets and thus improve the generalization performance of the model.

According to a fourth aspect of the present invention, there is provided a method for generating synthetic samples for expanding a training dataset of a predictive data-driven model for predicting an industrial time dependent process. The method comprises:

a) receiving, via an input channel, historical data of at least one condition parameter indicative of a condition under which the industrial time dependent process took place and at least one KPI provided for quantifying the industrial time dependent process;

b) applying, via a processor, a data-driven generative model to generate synthetic samples of the at least one condition parameter and the at least one KPI from the historical data, wherein the data-driven generative model is parametrized or trained based on a training dataset comprising real-data examples of the at least one condition parameter and the at least one KPI; and

c) providing, via an output channel, the synthetic samples to the training dataset of the predictive data-driven model.

According to an embodiment of the present invention, the synthetic samples comprise a synthetic sequence representative of a time series of the at least one condition parameter and the at least one KPI.

According to an embodiment of the present invention, the data-driven generative model comprises an RNN-MVAE model with the at least one condition parameter and the at least one KPI as input and a synthetic sequence of the at least one condition parameter and the at least one KPI as output. The RNN-MVAE model comprises a multimodal variational autoencoder (MVAE). The MVAE comprises two recurrent neural networks (RNNs) that act as an encoder-decoder pair for the at least one condition parameter. The MVAE comprises two RNNs that act as an encoder-decoder pair for the at least one KPI.

According to an embodiment of the present invention, the data-driven generative model comprises a Seq-MVAE model with the at least one condition parameter and the at least one KPI as an initial input and a synthetic sample of the at least one condition parameter and the at least one KPI as output. The Seq-MVAE model comprises a multimodal variational autoencoder (MVAE). The MVAE comprises two feed forward neural networks (FFNNs) that act as an encoder-decoder pair for the at least one condition parameter. The MVAE comprises two feed forward neural networks (FFNNs) that act as an encoder-decoder pair for the at least one KPI. Each decoder and encoder is coupled to a respective recurrent neural network (RNN). For each point in time the output of the Seq-MVAE is aggregated into a vector representative of the synthetic sequence.

The fact that the output of the Seq-MVAE is aggregated into a vector is independent from the way how decoder is coupled with RNN. These both steps may occur parallel.

According to a fifth aspect of the present invention, there is provided a method for predicting an industrial time dependent process. The method comprises:

a) receiving, via an input channel, currently measured data indicative of a current condition under which the industrial time dependent process currently takes place, wherein at least one key performance indicator (KPI) is provided for quantifying the industrial time dependent process;

b) receiving, via the input channel, at least one expected condition parameter indicative of a future condition under which the industrial time dependent process will take place within a prediction horizon;

c) applying, via a processor, a predictive data-driven model to an input dataset comprising the currently measured data and the at least one expected condition parameter to estimate a future value of the at least one KPI within the prediction horizon, wherein the predictive data-driven model is parametrized or trained according to a training dataset comprising historical data of the at least one condition parameter and the at least one KPI and synthetic samples of the at least one condition parameter and the at least one KPI; and

d) providing, via an output channel, a prediction of the future value of at least one KPI within the prediction horizon which is usable for monitoring and/or controlling the industrial time dependent process.

Optionally, the synthetic samples may be provided by a method according to the fourth aspect and any associated example.

According to a sixth aspect of the present invention, there is provided a method for predicting an industrial time dependent process, comprising:

a) receiving, via an input channel, previously measured data indicative of a past condition under which the industrial time dependent process took place, wherein at least one key performance indicator, KPI, is provided for quantifying the industrial time dependent process;

b) receiving, via the input channel, at least one condition parameter indicative of a current condition under which the industrial time dependent process currently takes place;

c) applying, via a processor, a predictive data-driven model to an input dataset comprising the previously measured data and the at least one condition parameter to estimate a current value of the at least one KPI, wherein the predictive data-driven model is parametrized or trained according to a training dataset comprising historical data of the at least one condition parameter the at least one KPI and synthetic samples of the at least one condition parameter and the at least one KPI; and

d) providing, via an output channel, a prediction of the current value of at least one KPI which is usable for monitoring and/or controlling the industrial time dependent process.

Optionally, the synthetic samples may be provided by a method according to the fourth aspect and any associated example.

According to another aspect of the present invention, there is provided a computer program product comprising a computer program with program code for performing a method as described above.

According to a further aspect of the present invention, there is provided a use of synthetic samples generated according to the fourth aspect and any associated example for expanding a training dataset of a predictive data-driven model for predicting an industrial time dependent process.

According to another aspect of the present invention, there is provided a computer readable medium having stored the program element as described above.

Advantageously, the benefits provided by any of the above aspects and examples equally apply to all of the other aspects and examples and vice versa.

As used herein, the term “predictive data driven model” may refer to a trained mathematical model that is parametrized according to a training dataset to reflect the dynamics of an industrial time dependent process. In some examples, the predictive data driven model may comprise a data driven machine learning model. As used herein, the term “machine learning” may refer to a statistical method that enables machines to “learn” tasks from data without explicitly programming, relying on patterns in the data instead. Machine learning techniques may comprise “traditional machine learning”—the workflow in which one manually selects features and then trains the model. Examples of traditional machine learning techniques may include decision trees, support vector machines, and ensemble methods. In some examples, the data driven model may comprise a data driven deep learning model. Deep learning is a subset of machine learning modeled loosely on the neural pathways of the human brain. Deep refers to the multiple layers between the input and output layers. In deep learning, the algorithm automatically learns what features are useful. Examples of deep learning techniques may include convolutional neural networks (CNNs), recurrent neural networks (such as long short-term memory, or LSTM), and deep Q networks. A general introduction into machine learning and corresponding software frameworks is described in “Machine Learning and Deep Learning frameworks and libraries for large-scale data mining: a survey”; Artificial Intelligence Review; Giang Nguyen et al., June 2019, Volume 52, Issue 1, pp 77-124. The predictive data driven model may comprise a stateful model, which is a machine learning model with a hidden state that is continuously updated with a new time step and contains information about an entire past of time series. Alternatively, the predictive data driven model may comprise a stateless model, which is a machine learning model that bases its forecast only on the inputs within a fixed time window prior to the current operation. In other words, the stateless model also relies on past values of degradation KPI and operating parameters on the input side. Alternatively, the data driven model may comprise a hybrid model, i.e. a combination of a stateful model and a stateless model, wherein the stateful model may comprise a combination of mechanistical pre-information about the process which is represented by a function with a predefined structure and stateful model which estimates parameters of this function.

As used herein, the term “current” refers to the most recent measurement, as the measurement for certain equipment may not be carried out in real time.

As used herein, the term “future” refers to a certain time point within a prediction horizon. The useful prediction horizon for degradation of an equipment may range between hours and months. The applied prediction horizon is determined by two factors. Firstly, the forecast has to be accurate enough to be used as a basis for decision. To achieve accuracy, input data of future production planning has to be available, which is the case for only a limited number of days or weeks into the future. Furthermore, the prediction model itself may lack accuracy due to the underlying prediction model structure or poorly defined parameters, which are a consequence of the noisy and finite nature of the historical data set used for model identification. Secondly, the forecast horizon has to be long enough to address the relevant operational questions, such as taking maintenance actions, making planning decisions.

As used herein, the term “unit” or “channel” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logical circuit, and/or other suitable components that provide the described functionality.

As used herein, the term “algorithm” may refer to a set of rules or instructions that will train the model to do what you want it to do.

As used herein, the term “model” may refer to a trained program that predicts outputs given a set of inputs.

As used herein, the term “classification” may refer to the use of a model to draw some conclusion from the input values given for training. It will predict the class labels/categories for the new data. The output variable in classification is categorical (or discrete).

As used herein, the term “regression” may refer to the use of a model to predict a value of the output variables based on functional dependences between model inputs and its outputs. The output variable in regression is numerical (or continuous).

These and other aspects of the present invention will become apparent from and be elucidated with reference to the embodiments described hereinafter.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 schematically shows a device for generating synthetic samples for expanding a training dataset of a predictive data-driven model for predicting an industrial time dependent process according to some embodiments of the present disclosure.

FIGS. 2A to 2C show an example of a MVAE model, showing how all modalities are generated under different combinations of missing modalities.

FIG. 3 illustrates a visualization of the Seq-MVAE architecture for a scenario commonly encountered in industrial dynamic processes.

FIG. 4 shows a comparison of the forecasting performance of the RNN-MVAE, the Seq-MVAE, and the LSTM forecasting models.

FIG. 5 shows the KPIs predicted by the LSTM model from the condition parameters (PCs) generated by the RNN-MVAE model, and comparing them to the corresponding generated KPIs.

FIG. 6 shows the KPIs predicted by the LSTM model from the PCs generated by the Seq-MVAE model, and comparing them to the corresponding generated KPIs.

FIG. 7 shows a comparison of the forecasting performance of the Seq-MVAE model versus that of an LSTM forecasting model for the real-world dataset.

FIG. 8 shows the performance of a predictive LSTM trained on a training set augmented by different amount of samples generated using different types of conditioning.

FIG. 9 schematically shows an apparatus for predicting an industrial time dependent process according to some embodiments of the present disclosure.

FIG. 10 schematically shows an apparatus for predicting an industrial time dependent process according to some other embodiments of the present disclosure.

FIG. 11 shows a flow chart illustrating a method for generating synthetic samples for expanding a training dataset of a predictive data-driven model for predicting an industrial time dependent process according to some embodiments of the present disclosure.

FIG. 12 shows a flow chart of a method for predicting an industrial time dependent process according to some embodiments of the present disclosure.

FIG. 13 shows a flow chart of a method for predicting an industrial time dependent process according to some other embodiments of the present disclosure.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

Machine learning is more and more applied in industrial applications. Machine learning needs a high number of training data, covering enough variations and also a sufficient large set of test data to test the quality of the trained model. This may be a major challenge in industrial application, where the data is generated during production runs. This may limit the availability of gathering more data. Dependent on the length of a production cycle (e.g., months, years), gathering the training data may become more challenging.

For example, on forecasting of process behavior in the chemical industry, some problems may limit the performance of non-linear machine learning models on the real-world dataset. The first problem may be the overall small size of the training set for the real-world data, while the second problem may be the slight difference in dynamics between the training and test sets caused by changes in the distribution of the process and/or storage condition data.

The changes in process data distribution may be caused for example by: catalyst bed exchange in the reactor, changes in plant equipment, changes of feed concentration, etc.

The problem of the differences between the training and test datasets may be difficult to overcome, since learning and modelling patterns and/or dynamics different from the training set is outside the scope of machine learning, and thus impossible to achieve for any machine-learning model without any further information about the test data.

For this reason, data augmentation via a data driven generative model is proposed to reduce the negative effects of the small size of the training set and/or the slight difference in dynamics between the training and test sets.

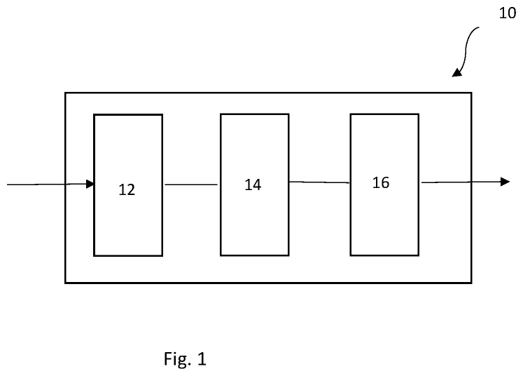

FIG. 1 schematically illustrates an example of a device 10 for generating synthetic samples for expanding a training dataset of a predictive data-driven model for predicting an industrial time dependent process. In some examples, prediction of an industrial time dependent process may be used to identify whether a chemical substance, a component, an equipment, and/or a system is deviating from or will deviate from its typical behavior in the future. In some examples, prediction of an industrial time dependent process may be used to identify the off-the-shelf performance of a chemical substance, a component, an equipment, and/or a system.

The device 10 comprises an input unit 12, a processing unit 14, and an output unit 16. The input unit 12, the processing unit 14, and the output unit 16 may be a software, or hardware dedicated to running said software, for delivering the corresponding functionality or service.

Each unit may be part of, or include an ASIC, an electronic circuit, a processor (shared, dedicated, or group) and/or memory (shared, dedicated, or group) that execute one or more software or firmware programs, a combinational logical circuit, and/or other suitable components that provide the described functionality.

The input unit 12 is configured to receive historical data of at least one condition parameter indicative of a condition under which the industrial time dependent process took place and at least one KPI provided for quantifying the industrial time dependent process. Examples of the condition may include an operating condition and a storage condition. The condition parameter may include operating parameters and/or storage parameters.

The at least one KPI may be selected from parameters comprising: a parameter contained in a set of measured process and/or storage condition data and/or a derived parameter representing a function of one or more parameters contained in a set of the measured process and/or storage condition data and/or storage condition data. The at least one KPI may be defined by a user (e.g. process operator) or by a statistical model e.g. an anomaly score measuring the distance to the “healthy” state of a chemical substance, component, equipment, and/or system in a multivariate space of relevant process and/or storage condition data, such as the Hotelling T² score or the DModX distance derived from principal component analysis (PCA). Here, the healthy state may refer to the bulk of states that are typically observed during periods in the historic process and/or storage condition data that were labelled as “usual”/“unproblematic”/“good” by an expert for the production process.

The historical data may comprise data collected from the similar or same types of chemical substance, component, equipment, and/or system.

The processing unit 14 is configured to apply a data-driven generative model to derive synthetic samples of the at least one condition parameter and the at least one KPI from the historical data. The data-driven generative model is parametrized or trained based on a training dataset comprising real-data examples of the at least one condition parameter and the at least one KPI.

An example of the data-driven generative model is a latent variable generative model, e.g. multimodal variational autoencoders (MVAEs). A latent representation, i.e. compressed feature vector, is generated with the help of neural networks suitable for handling time series, such as RNNs. Then, the latent representation is used to generate synthetic data by use of the data-driven generative model.

In an example, the data-driven generative model may comprise an RNN-MVAE model with the at least one condition parameter and the at least one KPI as input and a synthetic sequence of the at least one condition parameter and the at least one KPI as output. The RNN-MVAE model may comprise a multimodal variational autoencoder (MVAE). The MVAE may comprise two recurrent neural networks (RNNs) that act as an encoder-decoder pair for the at least one condition parameter. The MVAE may comprise two RNNs that act as an encoder-decoder pair for the at least one KPI. The RNNs may comprise at least one of: an echo state network (ESN), a gated recurrent unit (GRU) network, an ordinary differential equation (ODE) network, and a long short-term memory (LSTM) network.

In an example, the data-driven generative model may comprise a Seq-MVAE model with the at least one condition parameter and the at least one KPI as an initial input and a synthetic sample of the at least one condition parameter and the at least one KPI as output. The Seq-MVAE model comprises a multimodal variational autoencoder (MVAE). The MVAE comprises two feed forward neural networks (FFNNs) that act as an encoder-decoder pair for the at least one condition parameter. The MVAE comprises two feed forward neural networks (FFNNs) that act as an encoder-decoder pair for the at least one KPI. Each decoder and encoder are coupled to a respective recurrent neural network (RNN). For each point in time, the output of the Seq-MVAE is aggregated into a vector representative of the synthetic sequence. The RNNs may comprise at least one of: an echo state network (ESN), a gated recurrent unit (GRU) network, an ordinary differential equation (ODE) network, and a long short-term memory (LSTM) network.

The output unit 16 is configured to provide the synthetic samples to the training dataset of the predictive data-driven model.

In the following, we focus on the scenario of industrial aging process (IAP) forecasting, in particular, where the temporal evolution of a target KPI needs to be predicted based on a sequence of known process conditions represented by condition parameters. We draw upon insights from a series of variational autoencoders capable of modelling and generating data consisting of multiple modalities, to introduce a model capable of learning and generating truly multimodal time series under any combination of missing values. We evaluate the effectiveness of our generative model using two IAP datasets. The first one is an artificial dataset, where the differential equation relating the process conditions to the KPI is known. This dataset provides the conditions to unambiguously evaluate how well our generative model captures the underlying process dynamics, by directly comparing the KPIs generated by our novel generative model to those obtained by applying the underlying differential equation. The second dataset is a real-world dataset with a small number of sequences, which also exhibits a slight shift in the dynamics between the training and test sets. Using this dataset once again obtain way to unambiguously evaluate the effectiveness of our generative model, by observing how the predictive performance of a simple predictive model on the test set changes when the training set is augmented by different amounts of generated sequences, which have also been conditioned using different modalities.

### 1. Background

Variational autoencoders are generative models, which use the variational inference scheme to approximate the marginal likelihood of the data, which is intractable. To bypass this problem, the evidence lower bound (ELBO) is minimized instead:

ELBO(x)= [symbol] _{qϕ(z|x)}[λ log p_{θ}(x|z)]−βKL(q_{ϕ}(z|x)∥p(z)) (1)

Here KL(p, q) is the KL-divergence between two distributions, the parameters λ and β are balancing terms, and the distributions p and q are parametrized as encoding and decoding neural networks, allowing us to minimize the ELBO using gradient descent. In the context of a variational autoencoder, the first term in the ELBO (eq. 1) represents the reconstruction error, while the second is used for regularization of the approximate posterior, ensuring that it is well behaved and enabling efficient sampling based on the prior p(z). The framework of multimodal VAEs (MVAEs) was developed in a series of models which attempt to learn a joint probability distribution over multiple modalities.

First, we define multimodal data as set X of N different modalities, x1, x2, . . . , x_{N}. The central assumption is that given a common latent variable z, the individual modalities are conditionally independent, meaning that it is possible to factorize the joint distribution as:

p_{θ}(x₁, . . . ,x_{N},z)=p_{θ}(x₁|z) . . . p_{θ}(x_{N}|z)p(z).

Having the joint distribution in this form means that we can ignore missing modalities when evaluating the marginal likelihood, making it possible to calculate the ELBO based on only the set of currently present modalities, given by X={xᵢ|i-th modality is present}:

$$ELBO ( X ) = {E}_{q ϕ ( z \vert X )} \begin{matrix}⌊ {\sum }_{{x}_{i} ∈ X} {λ}_{i} log {p}_{θ} ( {x}_{i} \vert z ) ⌋ \\ - β KL ( {q}_{ϕ} ( z \vert X ) ‖ p ( z ) ]\end{matrix} \qquad ( 2 )$$

To handle the missing modalities, a naive implementation would have to define 2^{N} inference networks, one for each combination of missing and present modalities. This problem can be avoided thanks to the assumption of conditional independence of the modalities, which allows for the following approximation of the joint posterior:

$$p ( z \vert {x}_{1} , … , {x}_{N} ) = p ( z ) {{\prod }_{i = i}}^{N} \tilde{q} ( z \vert {x}_{i} ) .$$

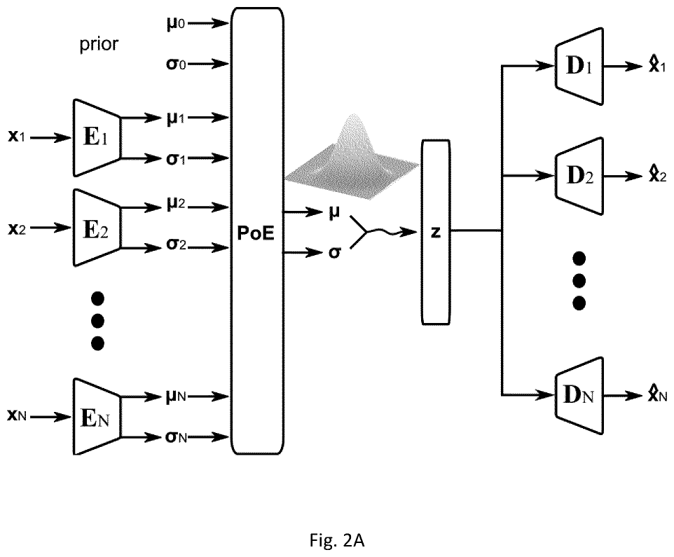

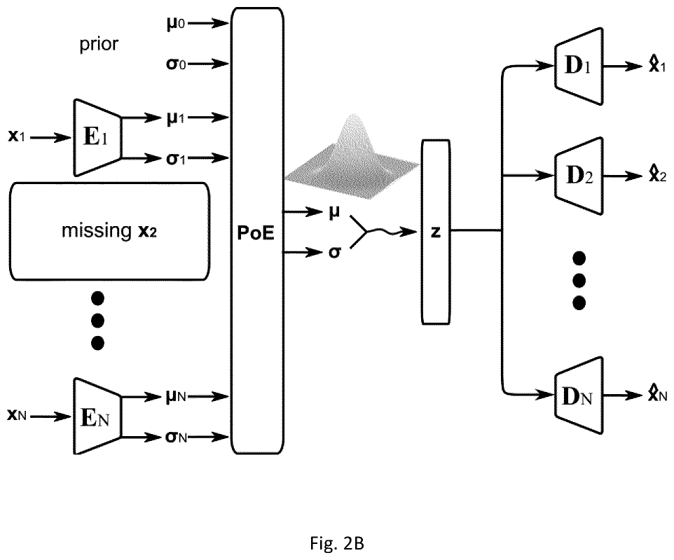

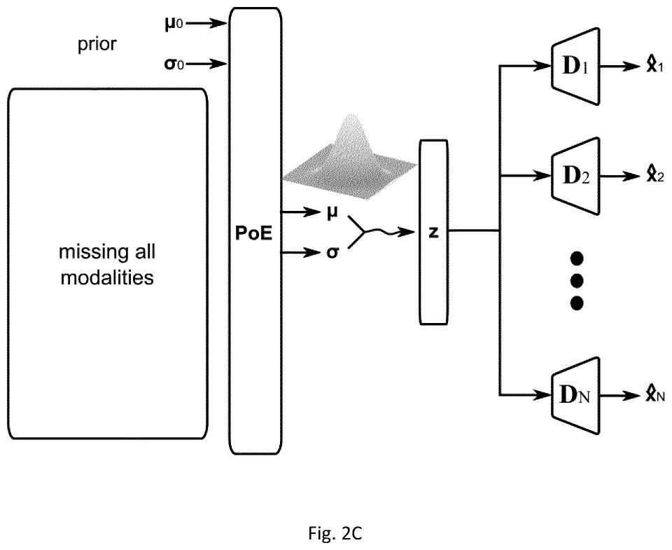

This gives us the product of experts (PoE), including a prior expert, which as usual is taken to be the standard normal distribution. The PoE is used to combine the distributions of the N individual modalities into an approximate joint posterior. Given that the distributions of the individual modalities are all Gaussian, we can replace 2^{N} multimodal inference networks required by an efficient computation based on the distributions given by N uni-modal networks. For example, FIGS. 2A to 2C illustrate an example of a MVAE model, showing how all modalities are generated under different combinations of missing modalities. Finally, a latent representation is sampled from the joint distribution and is passed to the N independent decoder networks, who then generate their designated modality.

2. Sequential Multimodal Variational Autoencoder

The MVAE model presented in the previous section is only capable of generating single samples and needs to be adapted in order to generate sequential data. First, we present a straightforward way of generating sequential data with the MVAE model, by using RNNs as encoders and decoders, and argue why this approach is suboptimal. Next, we will introduce our Seq-MVAE model, which is an extension of the MVAE capable of generating multimodal time series one time-point at a time.

2.1. Using RNNs as Encoders and Decoders

One possible extension of the MVAE towards sequential data would be to use RNNs as the encoder and decoder networks for the sequential modalities, producing a single joint posterior for the entire sequences of all modalities. This architecture is analogous to the one used in (Wu and Goodman, 2018), with architectures being used in other works dealing with the generation of sequences. We will call this model the RNN-MVAE.

2.1.1. RNN-MVAE Architecture

We start off by using an RNN followed by fully connected layers to parametrize the variational approximate posterior of each sequential modality as follows:

μᵢ,σᵢ=f_{i,ϕ}(RNN_{i,ϕ}(xᵢ(≤T))),q_{ϕ}(zᵢxᵢ(≤T))= [symbol] (μᵢ,σᵢ).

This means that we obtain one approximate posterior representing an entire sequence of a given modality, so after the modality-specific distributions are combined using the PoE, the result is one joint posterior distribution for an entire multimodal sequence.

$${q}_{ϕ} ( z \vert X ) = N ( 0 , I ) {{\prod }_{{x}_{i} ∈ X}}^{N} {q}_{ϕ} ( {z}_{i} \vert {x}_{i} ( \leq T ) ) .$$

Finally the individual decoder networks, which are also RNNs, use the latent state z sampled from the joint posterior as an initial conditioning, either by including it as an initial hidden state or by including it with the input at every time step, after which they attempt to reconstruct the corresponding modalities:

\hat{x}ᵢ(t)=RNN_{i,θ}(z;\hat{x}ᵢ(<t)),z˜q(z|X).

2.2.2. Models and Training Hyperparameter Details

For the Seq-MVAE model the encoders and decoders consist of fully connected networks with two hidden layers with a dimensionality of 128, while the RNNs in our case were LSTMs with one layer also with a dimensionality of 128. The size of the latent representations was 64, and we also shared weights across the network by using feature extractor layers of size 128 for each modality and the latent representation.

For the RNN-MVAE we used LSTMs with a dimensionality of 512 for the encoders, decoders and for the latent representation, in order to allow for more information to be encoded into the hidden and latent states, which in this case would need to describe the entire dynamics of the sequences.

Finally as a forecasting model for predicting the KPI from the given PCs we use an LSTM with a dimensionality of 512 and 128 for the artificial and real-world datasets, respectively. The generative models are trained with Adam with 10⁻³ learning rate, reducing it by a factor of 0.2 on plateau, and using early stopping based on the validation set. A batch size of 128 was used for the artificial dataset and 32 for the real-world dataset. The forecasting models are trained with stochastic gradient descent with Nesterov momentum, once again with a learning rate of 10⁻³ and a momentum of 0.95, with batch sizes of 32 and 16 for the artificial and real-world datasets respectively. The learning rate adaptation and early stopping were employed in the same way as with the generative models.

The RNN-MVAE may have certain limitation, as the dynamics of many time series may be too complex to capture in just a single latent variable of the RNN-MVAE, and the sampling from the posterior as the single source of variability will likely make the RNN-MVAE struggle to recreate the temporal variability in the original time series, especially with longer sequences.

2.2 Generating Individual Multimodal Sequences in a Time Dependent Manner

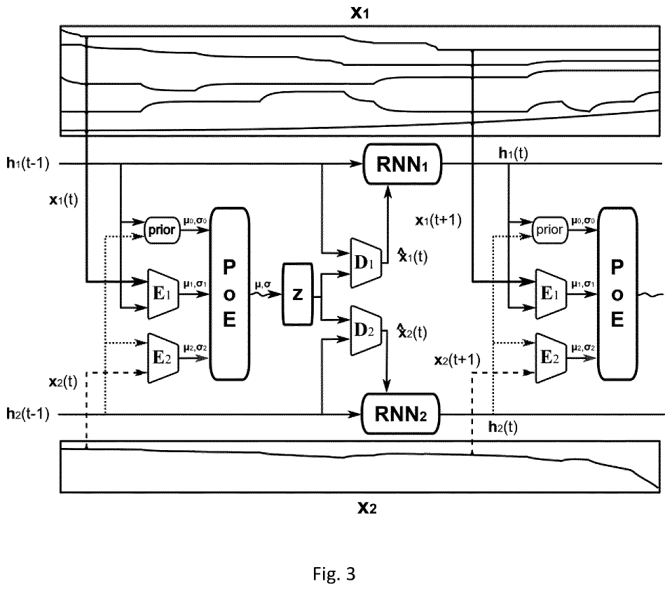

In order to make the generative model capable of reproducing the time dynamics of any multimodal sequence more accurately, The Seq-MVAE model, uses the basic MVAE architecture to generate individual multimodal time samples one at a time, while using RNNs to maintain the temporal context and dependence across samples generated at different time points within each sequence. A visualization of the overall architecture for a scenario commonly encountered in industrial dynamic processes is given in FIG. 3, which is based on a simple example with related time series given as separate modalities, one of which is univariate and one of which is multivariate.

To keep the notation more uniform we assume that all modalities are time series of length T, however due to the independent handling of modalities it is easy to see that each modality can be a sequence of any length, which also includes non-sequential data as a special case. We first describe how the time dependent joint posterior is obtained. For each modality, given the current time sample of the modality xᵢ(t) along with the hidden state from the previous time point hᵢ(t−1), which is produced by the RNN used to maintain the time context for the given modality, the modality-specific, time dependent posteriors are obtained as follows:

μᵢ(t),σᵢ(t)=f_{i,ϕ}(xᵢ(t),hᵢ(t−1))q_{ϕ}(zᵢ(t)|xᵢ(≤t),z(<t))= [symbol] (μᵢ(t),σᵢ(t)).

Instead of using a standard normal prior expert, in order to encode the temporal context for each modality we use a neural network dependent on the previous hidden state to obtain the prior mean and variance:

μₚᵣᵢₒᵣ(t),σₚᵣᵢₒᵣ(t)=f_{ϕ}^{prior}(h₁(t−1), . . . ,h_{N}(t−1)).

Finally, the joint posterior for the current time point is obtained by using the PoE to combine the approximate posteriors of the individual modalities:

$${q}_{ϕ} ( z ( t ) \vert X ( \leq t ) , z ( < t ) ) ) = 𝒩 ( {μ}_{prior} ( t ) , {σ}_{prior} ( t ) ) {{\prod }_{{x}_{i} ∈ X ( t )}}^{N} {q}_{ϕ} ( {z}_{i} ( t ) \vert {x}_{i} ( \leq t ) , z ( < t ) ) .$$

The decoding process also needs to be modified in order to ensure that the generated sequences maintain the proper time dynamics. Once again we use N decoding networks f_{i,θ}, one for each modality, which use the latent representation zᵢ(t) sampled from the joint posterior along with the hidden state hᵢ(t−1) to generate a new time sample:

\hat{x}ᵢ(t)=f_{i,θ}(z(t),hᵢ(t−1)),

(z(t)˜q_{ϕ}(z(t)|X(≤t),z(<t))

For our implementation we combine the different hidden states by simply taking their mean, thereby keeping the size of the prior network independent of the number of modalities. Using the generated time samples \hat{x}ᵢ(t) we use the RNNs to update the time context and calculate the new set of hidden states hi(t) which will be used for the generation of the subsequent time samples:

hᵢ(t)=RNNᵢ(xᵢ(t),z(t)).

Finally, the multimodal ELBO in Eq. 2 is modified to a time dependent ELBO, calculating the loss for all modalities present, as shown in Eq. 3: This formulation of the ELBO allows for straightforward handling of missing and differing sampling rates, by simply leaving out the modality at any time point where a value is missing or it has not been sampled. Additionally, the Seq-MVAE may easily in-corporate non-sequential modalities, simply by repeatedly proving them as a present modality after a number of time steps have passed. In the extreme they would be included only once at the beginning of the sequence or at every time point. For training, we recommend to use the sub-sampled paradigm discussed in (Wu and Goodman, 2018), with the additional possibility of choosing which modalities to exclude once per sequence or at every time point within the sequence.

$$ELBO ( X ( \leq T ) ) = {E}_{{q}_{ϕ}} ( z ( \leq T ) \vert X ( \leq T ) ) ⌊ \text{?} {\sum }_{{x}_{i} ∈ X ( t )} {λ}_{i} log {p}_{θ} ( {x}_{i} ( t ) \vert z ( \leq t ) , x ( < t ) ) - β KL ( {q}_{ϕ} ( z ( t ) \vert X ( \leq t ) , z ( < t ) ) ‖ {p}_{ϕ} ( z ( t ) \vert X ( \leq t ) , z ( < t ) ) ) ] . \qquad ( 3 )$$

$$\text{?} \text{indicates text missing or illegible when filed}$$

2.3 Conditioning on Different Modalities

Another major advantage of the Seq-MVAE is the model's ability to sample from the joint posterior distribution conditioned on any combination of modalities. This enables us to condition our model's posterior based on any provided modalities regardless of whether they are sequential or non-sequential, giving us a great degree of control over the properties of the multimodal sequences we want to generate for data augmentation, as well as making our model capable of missing values imputation. New synthetic samples can be generated by sampling in the following ways: from the prior distribution with no modalities as input (1), from the posterior conditioned on either the condition parameters (PCs) (2), the KPIs (3) or both (4). In the first case, the resulting synthetic samples will be one a completely independent one, where the functional relationship between the PCs and KPIs is maintained. In the second case, the generated PCs should closely resemble the PCs used as input/conditioning, and the generative model will try to generate the KPIs that are still properly functionally related to the PCs used as input. This applies analogously for the third case, while in the fourth and final case, the generative model will attempt to produce synthetic samples that very closely resemble the PCs and KPIs given as input, with only small differences caused by the random sampling of the latent variable from the joint posterior.

Conditioning the generative model with existing PCs or KPIs can be used to guide the generated samples depending on the task requirements. For example, if we want to increase the model accuracy within the operating ranges which are seldom observed in the reality, e.g. low feed load in the plant (here, it represents the condition parameter). Such regime is mostly observed during the start up of the plant, because most part of the time the plant is operated with a maximal feed load. That means that we very often do not have enough real data to train the model with such values of condition parameters.

Instead, we would feed the generative model these values of condition parameters and obtain generated KPIs that would simulate what happens in the plant in these conditions. Similarly, if we want to train our model for a particular type of KPI cycle (e.g. optimal or suboptimal production), one could give these types of KPI cycles to the generative model to generate the corresponding PCs.

### 3. Experiments

To evaluate our proposed generative model, we analyzed two examples from the chemical industry. Here, we focused on a particular case of industrial aging processes (IAPs), namely the deactivation of the heterogeneous catalyst due to coking, e.g., surface deposition of elementary carbon in the form of graphite. One of the most important features of such degradation processes are distinct memory effects, where the value of the inputs in the plant x(t), which we will refer to as condition parameters (CPs), effects the out-put y(t′), as measured by some key performance indicators (KPIs), at much later time points t′>t. Therefore, the catalyst deactivation can be observed only on long-term timescales, which makes such processes very challenging to model using mechanistic models, i.e. as sets of differential equations describing the degradation process. Given enough historical data, we can use machine learning to model the degradation process in a data-driven manner instead. However, the data acquisition in real-world chemical plants is highly expensive, leading to a lack of historical data for training. Additionally, covariate shifts can often occur due to the sensitive and changing conditions within the plant itself, which makes this an excellent scenario to test the effectiveness of data augmentation using generative modelling. In this work, we consider two datasets. The first dataset represents artificial data, which is generated using a mechanistic model meant to simulate a degradation process. The second dataset contains real-world data from a large-scale plant at BASF.

3.1 Artificial Dataset

The reason for working with artificial data based on a deterministic mechanistic model, is that we can know the exact functional relationship between the PCs x(t) and its KPIs y(t). Since we expect our generative model to be able to learn this relationship, we can use our mechanistic model as a ground truth to evaluate the performance of the generative model.

For our artificial use case, we analyzed an example of catalyst deactivation in a continuously operated fixed-bed reactor. The catalyst deactivation over time causes unacceptable conversion rates in the reaction process, requiring catalyst regeneration or replacement. This process step characterizes the end of one cycle.

Based on the current operating conditions of the process and the unobservable state variable of the system (here, the catalyst activity), we used a mechanistic model to generate a multivariate time series [x(t), y(t)] for roughly 1000 degradation cycles, which represents 25 years of historical data. The final artificial dataset is composed of 6 PCs x(t) and one KPI y(t), which in this case is the conversion rate. The catalyst activity A(t) is an unobservable state variable and therefore not part of the dataset. It is important to note that the system output y(t) is not only affected by current process parameters x(t), but also the catalyst activity A(t), which decreases non-linearly over each cycle.

3.2. Real-World Dataset

This dataset is five times smaller than the full artificial dataset and contains process and/or storage condition data for the production of aldehyde (ALD) in a continuous large-scale production plant at BASF. Here, we will give you only a brief description of the process. In this case as well, catalyst in the reactor suffers from coking, which leads to the reduction of catalyst activity and increasing fluid resistance. The latter can be measured by an increasing pressure drop over the reactor (Δp). The real-world dataset consists of 12 PCs x(t) and one KPI y(t) and contains seven years of process and/or storage condition data with 336 degradation cycles belonging to three different catalyst batches. Each catalyst batch slightly different dynamics owing to small differences between the catalysts in each batch. The input dataset contains four directly measured variables, with the additional eight variables representing engineered features.

3.3. Models and Training

For both chemical plant datasets, we separate the data into two sequential modalities, one modality containing all of the PCs for a cycle and the other containing the KPI. The reason why we cannot split the PCs into separate modalities is the assumption of conditional independence between the modalities. Even though the PCs are independent on their own, they are not conditionally independent given the differential equations governing the process dynamics and the hidden catalyst activity, which represent our latent variable z. Knowing the differential equations and the state of the catalyst activity, having information about some of the PCs allows us to infer possible values for the missing ones.

We use the same Seq-MVAE and RNN-MVAE model across all experiments and keep the model sizes relatively small to reduce the risk of overfilling due to the small dataset sizes. Additionally as a forecasting model for predicting the KPI from the given PCs we use a single layer LSTM.

For training the datasets are split into a training, validation and test set, with ratios of 0.8, 0.1, 0.1 for the artificial dataset and 0.68, 0.7, 0.25 for the real-world dataset. In the real-world dataset, data from two of the three catalyst batches is shuffled into the training and validation sets, while the test set contains data exclusively from the third batch, producing the aforementioned covariate shift.

As mentioned previously, for the generative models we use the semi-supervised procedure, where for the semi-supervised case the modalities were removed as entire sequences, and not onetime point at a time.

### 4. Evaluation

4.1 Artificial Dataset

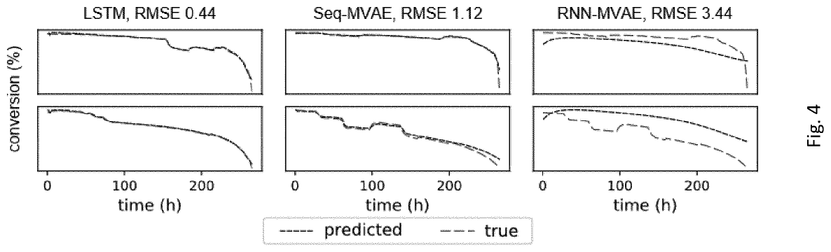

Forecasting. First we will examine how the generative models perform in the degradation forecasting scenario described in Section 3, where the curve of a KPI describing catalyst degradation over time is predicted based on the sequence of PCs used to control the plant. Both the Seq-MVAE and RNN-MVAE models are not trained for forecasting, since during the semi-supervised training procedure the loss for the missing modalities is not calculated, so the model is never explicitly trained to perfectly predict the missing modalities based on the present ones. Still, a generative model should be accurately capture the relationship between the PCs and KPIs and perform reasonably well compared to a dedicated forecasting model. On FIG. 4 we can see a comparison of the forecasting performance of the simple RNN-MVAE, the Seq-MVAE and the LSTM forecasting models. As expected, the RNN-MVAE fails to capture the within sequence dynamics and only predicts an average degradation curve, with an RMSE of 3.44. On the other hand, both the LSTM and the Seq-MVAE models predict the course of the KPI accurately, with the error of the Seq-MVAE being 1.12, slightly higher than the one of the dedicated forecasting model. The differences inaccuracy between the Seq-MVAE and forecasting LSTM are likely owing to the training procedure which doesn't prioritize accurate forecasts. Modifying the training procedure to calculate the loss for the excluded modalities is likely to increase the performance, but then the procedure would not be applicable to datasets with actual missing values.

Modelling the differential equation. A major advantage of the artificial dataset is that the relation between the PCs and KPIs is known exactly, so we can exploit this fact to examine how well the generative models reproduce the relation between these two modalities. We do this by using a generative model to produce two sequential modalities, then giving the generated PCs as an input to mechanistic model to obtain the true KPIs corresponding to these generated PCs, and finally calculating the RMSE between true KPIs and the generated ones to obtain the modelling error, which captures how well the generated models can reproduce the dynamics of the mechanistic model. This setting allows us to evaluate the model in more detail than the forecasting scenario, since we can also evaluate how accurately the multimodal sequences generated with different types of conditioning, including entirely new sequences generated with no conditioning, capture the underlying dynamics defined by the mechanistic model.

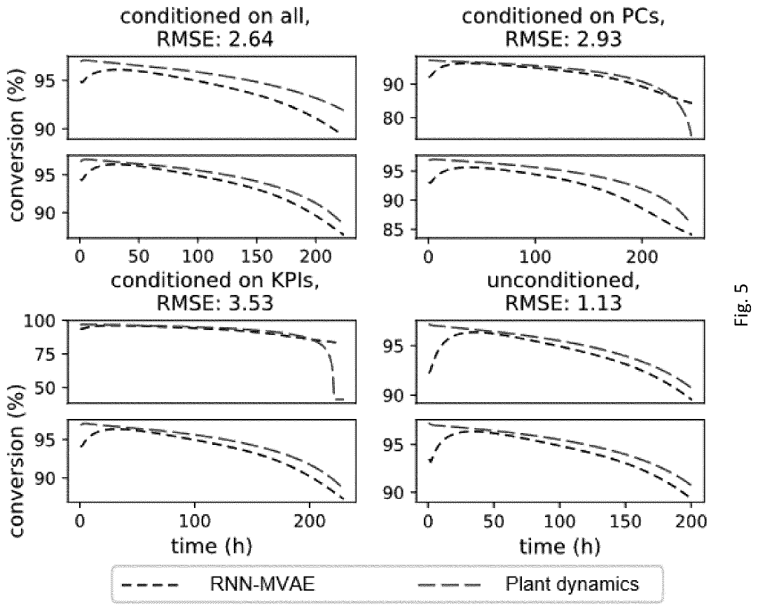

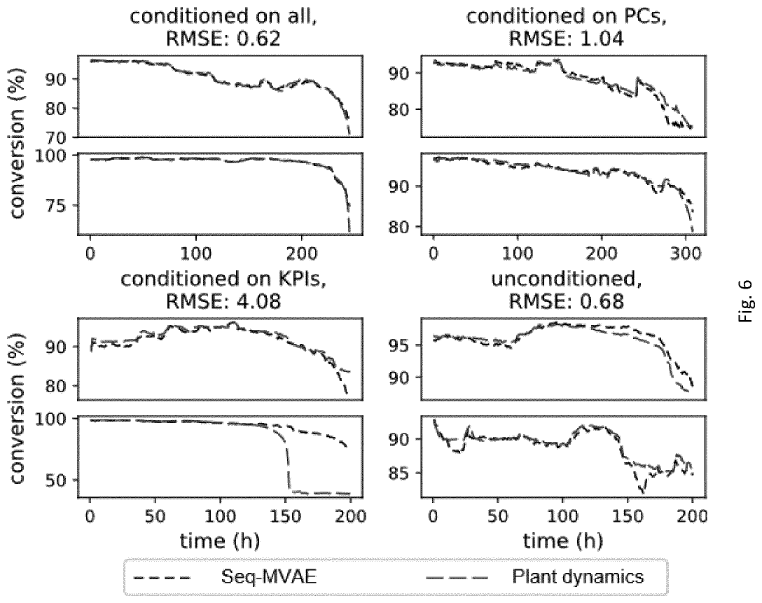

The results are shown on FIGS. 5 and 6 for the RNN-MVAE and Seq-MVAE, respectively. The results clearly show that the quality of the generated samples of the Seq-MVAE model is much higher than those of the RNN-MVAE. We see that the RNN-MVAE sequences display virtually no internal dynamics beyond the long term degradation trend, whereas the Seq-MAE samples show dynamics close to those of the true artificial dataset, with the modelling error being significantly smaller for the Seq-MVAE in all but the case where the models are conditioned on the KPIs.

It is precisely this case of conditioning the models on the KPIs that is interesting, since the largest difference modelling errors for both models are found with this type of conditioning. The reason for this is that one particular cycle of KPIs can be produced by many different combinations of PCs, making this case degenerate. Since there is no single set of PCs corresponding to a given KPI, it is expected any model of this type is likely to struggle when generating the PCs, so having a larger error is no surprise. Still, we can see that for many sequences, the modelling error of the Seq-MVAE is small, with the larger average error being driven by a subset of samples where the dynamics are captured particularly poorly. It is also interesting to see that the Seq-MVAE captures the model dynamics very accurately when generating sequences without any conditioning, with the modelling error being almost as small as when conditioning on both the KPIs and the PCs.

These results clearly show the advantages of the Seq-MVAE architecture over the RNN-MVAE for the case of highly dynamics sequential data. The modelling error is significantly lower in all but the degenerate case, and the within sequence dynamics are reproduced in a manner close to those of the artificial dataset itself.

4.2. Real-World Dataset

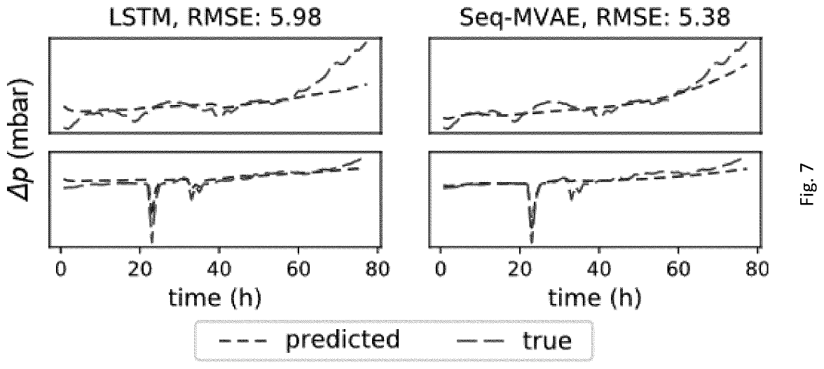

Forecasting. As with the artificial dataset, first we evaluate how the Seq-MVAE model performs on the IAP forecasting task compared to the forecasting LSTM model. The results are shown on FIG. 7, where unlike for the artificial dataset we can see that the Seq-MVAE outperforms the LSTM model. In the case of small data and covariate shift, the semi-supervised training procedure for the Seq-MVAE turns out to be an advantage. Since the Seq-MVAE is not directly trained to forecast the KPI from the PCs, it does not overfit to the training set as much as the LSTM model leading to a better performance on the test set.

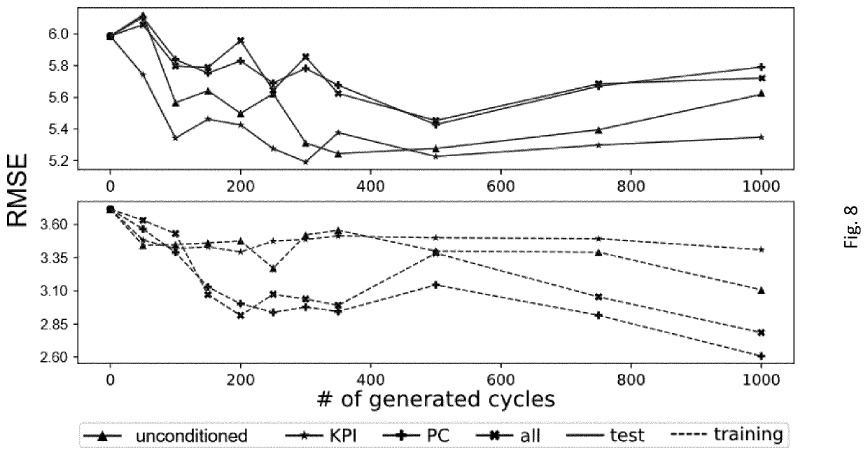

Data augmentation. The main goal of developing the Seq-MVAE is to use the generated data for data augmentation for small datasets, which is why we chose to evaluate the generative model by measuring how much the regression performance of the baseline forecasting LSTM model improves when augmenting the training dataset with data from the Seq-MVAE. We added different amounts of generated samples to the training dataset, generated using all four types of conditioning, and retrained and re-evaluated the predictive model 20 times for each setting to obtain more stable estimates of the performance changes due to data augmentation. On FIG. 8 we see the results of these evaluations. We see that performance significantly increases across all types of conditioning after adding 100 generated samples, and reaching its maximum from 350 to 500 added samples. This clearly demonstrates that data augmentation using our Seq-MVAE model can greatly increase predictive performance in the face of small amounts of data and differences between the training and test sets. Further increasing the amount of generated data seems to once again start degrading performance, meaning that a certain balance between real and generated samples is needed to achieve optimal performance.

The best overall performance is achieved when generating from the posterior conditioned on the KPIs and the unconditioned model, with the RMSE reaching 5.19 compared to the RMSE of 5.98 for the LSTM model trained only on the original training data, which is a 13% improvement in performance. A plausible reason for the improved performance of these two types of conditioning is that they produce data with higher variability, with the KPI conditioned model having a weak conditioning that allows for the generation of different sets of PCs for the same KPI, while the other model has no conditioning at all and is free to generate completely new samples. Another reason for the improved performance with samples from the KPI conditioned model is that as seen in FIG. 6, the LSTM forecast model struggles to properly predict the quick rise of the KPI values at the end of each cycle. When conditioned on the KPls, the Seq-MVAE generates KPIs that are very similar to the ones used for conditioning, which results in the model seeing many more examples of such steep rises of the KPI values with different accompanying PCs, making it learn to generalize and predict the exponential growth of the KPI more accurately. Another observation is that the two best performing types of conditioning also exhibit the smallest reduction in error on the original training dataset, once again showing that the samples they produce are more diverse, but not so different that they would also cause an increase in the error.

Finally, we also examine how the predictive LSTM performs on the test set when trained exclusively on data generated by the Seq-MVAE. In order to make a fair comparison, for each type of conditioning we generated 256 samples, the same number as the training set, and trained the LSTM with the same hyperparameters as with the original training set. We repeated this procedure 20 time, each time generating a new set of sequences to get a stable estimate of the error. The results are presented on Table 1. Interestingly, here we largely see the same pattern as with the data augmentation, where training on the generated samples conditioned on the KPI leading to the best performance, even outperforming the original training dataset. The data generated without conditioning once again has the second lowest error on the test set, with a performance similar to the original training set, while conditioning on the PCs or both modalities once again leads less diverse data with lower errors on the original training set but high errors on the test set. This experiment once again confirms our conclusions from the data augmentation experiments, which is that having control over the properties of the generated data allows us to pro-duce diverse data that still maintains the relation between the modalities, which is crucial for improving performance in scenarios with small datasets and/or covariate shifts.

TABLE 1

| | original | conditioning | | | |
|---|---|---|---|---|---|
| | data | all | PCs | KPI | none |
| test set | 5.98 | 6.38 | 6.79 | 5.57 | 6.00 |
| training set | 3.70 | 4.00 | 5.04 | 5.44 | 5.40 |

Accordingly, the Seq-MVAE generative model for multimodal time series is also compatible with missing data and non-sequential modalities. The model is also capable of generating data conditioned on known modalities, providing a high degree of control over the types of data being generated. We use this model to tackle a challenging machine learning scenario encountered in many datasets from real world processes, where data is scarce and subject to covariate shifts.

Taking the problem of forecasting industrial aging processes as a case study, we show that our generative model is capable of learning and recreating the temporal dynamics within and between the different modalities, and show that controlling the properties of the data being generated is crucial to achieving the best improvement in performance with data augmentation.

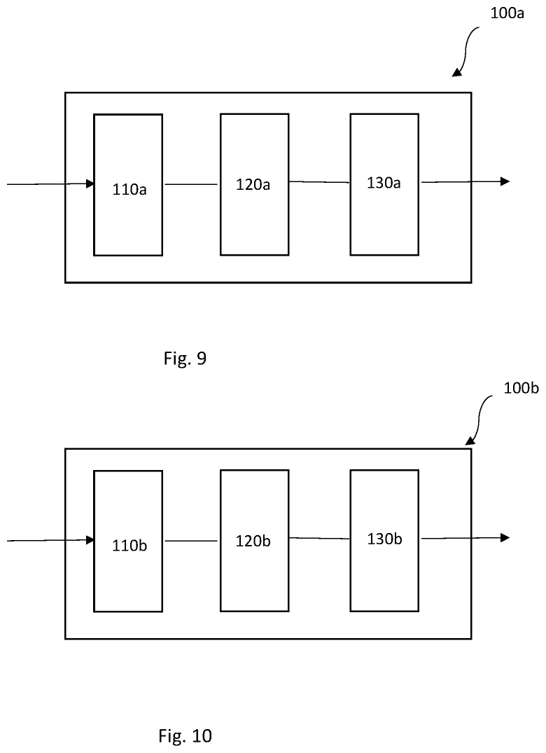

FIG. 9 schematically shows an apparatus 100a for predicting an industrial time dependent process, in particular for predicting a future value of KPI(s).

The apparatus 100a comprises an input unit 110a, a processing unit 120a, and an output unit 130a. The input unit 110a, the processing unit 120a, and the output unit 130a may be a software, or hardware dedicated to running said software, for delivering the corresponding functionality or service. Each unit may be part of, or include an ASIC, an electronic circuit, a processor (shared, dedicated, or group) and/or memory (shared, dedicated, or group) that execute one or more software or firmware programs, a combinational logical circuit, and/or other suitable components that provide the described functionality.

The input unit 110a is configured to receive currently measured data indicative of a current condition under which the industrial time dependent process currently takes place. At least one key performance indicator (KPI) is provided for quantifying the industrial time dependent process.

The at least one KPI may be selected in dependence on the use cases. Taking the industrial aging process as an example, despite the large variety of affected asset types in a chemical production plant, and the completely different physical or chemical degradation processes that underlie them, the selected parameters representing the one or more degradation KPIs may have at least one of the following characteristics:

On a time scale longer than a typical production time scale, e.g., batch time for discontinuous processes or typical time between set point changes for continuous processes, the selected parameters change substantially monotonically to a higher or lower value, thereby indicating an occurrence of an irreversible degradation phenomenon. The term “monotonic”, or “monotonically”, means that the selected parameters representing the degradation KPIs either increase or decrease on a longer time sale, e.g., the time scale of the degradation cycle, and the fluctuations on a shorter time scale do not affect this trend. On shorter time scales, the selected parameters may exhibit fluctuations that are not driven by the degradation process itself, but rather by varying condition parameters or background variables such as the ambient temperature. In other words, the one or more degradation KPIs are to a large extent determined by the condition parameters, and not by uncontrolled, external factors, such as bursting of a flawed pipe, varying outside temperature, or varying raw material quality.

The selected parameters may return to their baseline after a regeneration phase. As used herein, the term “regeneration” may refer to any event/procedure that reverses the degradation, including exchange of process equipment or catalyst, cleaning of process equipment, in-situ re-activation of catalyst, burn-off of cokes layers, etc.

The input unit 110a is configured to receive at least one expected condition parameter indicative of a future condition under which the industrial time dependent process will take place within a prediction horizon.

The condition parameter may include e.g. operating parameters and/or storage parameters.

The at least one expected condition parameter may be known and/or controllable over the prediction horizon instead of uncontrolled, external factors. Examples of the uncontrolled, external factors may include catastrophic events, such as busting of a flawed pipe. Further examples of the uncontrolled, external factors may include a less catastrophic, but more frequent external disturbance, such as varying outside temperature, or varying raw material quality. In other words, the one or more expected condition parameters may be planned or anticipated over the prediction horizon.

The processing unit 120a is configured to apply a predictive data-driven model to an input dataset comprising the currently measured data and the at least one expected condition parameter to estimate a future value of the at least one KPI within the prediction horizon. The predictive data-driven model is parametrized or trained according to a training dataset comprising historical data of the at least one condition parameter and the at least one KPI and synthetic samples of the at least one condition parameter and the at least one KPI, which are optionally provided by a device as described above.

In other words, an apparatus is proposed for predicting an industrial time dependent process, such as a time dependent process in a chemical production plant, based on a data driven model. The data driven model is trained using real world data and synthetic data. The synthetic data is derived from historical data information and represents the correlation in the historical data. The synthetic data is generated with the help of neural networks, such as RNN-MVAEs or Seq-MVAEs. The synthetic data thus increases the span of the training set. The increased span of the training set can help up bridge the gap between the training and test sets and thus improve the generalization performance of the predictive data driven model.

The output unit 130a is configured to provide a prediction of the future value of at least one KPI within the prediction horizon which is usable for monitoring and/or controlling the industrial time dependent process.

As application examples, the method may be used to predict and forecast at least one of the following degradation processes in a chemical production plant: deactivation of heterogeneous catalysts due to coking, sintering, and/or poisoning; plugging of a chemical process equipment on process side due to coke layer formation and/or polymerization; fouling of a heat exchanger on water side due to microbial and/or crystalline deposits; and erosion of an installed equipment in a fluidized bed reactor. Further application examples may include load forecasting and battery discharge forecasting.

FIG. 10 schematically shows an apparatus 100b for predicting an industrial time dependent process, in particular for predicting a current value of KPI(s).

The apparatus 100b comprises an input unit 110b, a processing unit 120b, and an output unit 130b. The input unit 110b, the processing unit 120b, and the output unit 130b may be a software, or hardware dedicated to running said software, for delivering the corresponding functionality or service. Each unit may be part of, or include an ASIC, an electronic circuit, a processor (shared, dedicated, or group) and/or memory (shared, dedicated, or group) that execute one or more software or firmware programs, a combinational logical circuit, and/or other suitable components that provide the described functionality.

The input unit 110b is configured to receive previously measured data indicative of a past condition under which the industrial time dependent process took place. At least one key performance indicator, KPI, is provided for quantifying the industrial time dependent process.

The input unit 110b is configured to receive at least one condition parameter indicative of a current condition under which the industrial time dependent process currently takes place.

The processing unit 120b is configured to apply a predictive data-driven model to an input dataset comprising the previously measured data and the at least one condition parameter to estimate a current value of the at least one KPI. The predictive data-driven model is parametrized or trained according to a training dataset comprising historical data of the at least one condition parameter the at least one KPI and synthetic samples of the at least one condition parameter and the at least one KPI, which are optionally provided by a device as described above.

In other words, an apparatus is proposed for predicting an industrial time dependent process, such as the off-the-shelf performance of an enzyme, based on a data driven model. The data driven model is trained using real world data and synthetic data. The synthetic data is derived from historical data information and represents the correlation in the historical data. The synthetic data is generated with the help of a neural network, such as RNN-MVAEs or Seq-MVAEs. The synthetic data thus increases the span of the training set. The increased span of the training set can help us bridge the gap between the training and test sets and thus improve the generalization performance of the predictive data driven model.

The output unit 130b is configured to provide a prediction of the current value of at least one KPI which is usable for monitoring and/or controlling the industrial time dependent process.

As application examples, the method may be used to predict off-the-shelf performance of a chemical substance (e.g., enzyme), component (e.g., battery), equipment, and/or system.

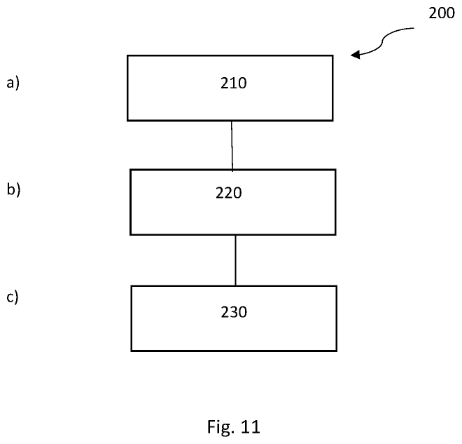

FIG. 11 shows a flow chart illustrating a method 200 for generating synthetic samples for expanding a training dataset of a predictive data-driven model for predicting an industrial time dependent process.

In step 210, historical data of at least one condition parameter indicative of a condition under which the industrial time dependent process took place and at least one KPI provided for quantifying the industrial time dependent process are received via an input channel.

In step 220, i.e. step b), a data-driven generative model is applied, via a processor, to generate synthetic samples of the at least one condition parameter and the at least one KPI from the historical data. The data-driven generative model is parametrized or trained based on a training dataset comprising real-data examples of the at least one condition parameter and the at least one KPI.

In some examples, the synthetic samples may comprise a synthetic sequence representative of a time series of the at least one condition parameter and the at least one KPI.

In some examples, the data-driven generative model may comprise a Seq-MVAE model with the at least one condition parameter and the at least one KPI as an initial input and a synthetic sample of the at least one condition parameter and the at least one KPI as output. The Seq-MVAE model comprises a multimodal variational autoencoder (MVAE). The MVAE comprises two feed forward neural networks (FFNNs) that act as an encoder-decoder pair for the at least one condition parameter. The MVAE comprises two feed forward neural networks (FFNNs) that act as an encoder-decoder pair for the at least one KPI. Each decoder and encoder are coupled to a respective recurrent neural network (RNN). For each point in time the output of the Seq-MVAE is aggregated into a vector representative of the synthetic sequence.

In some examples, the data-driven generative model may comprise an RNN-MVAE model with the at least one condition parameter and the at least one KPI as input and a synthetic sequence of the at least one condition parameter and the at least one KPI as output. The RNN-MVAE model comprises a multimodal variational autoencoder (MVAE). The MVAE comprises two recurrent neural networks (RNNs) that act as an encoder-decoder pair for the at least one condition parameter. The MVAE comprises two RNNs that act as an encoder-decoder pair for the at least one KPI.

In step 230, the synthetic samples are provided, via an output channel, to the training dataset of the predictive data-driven model.

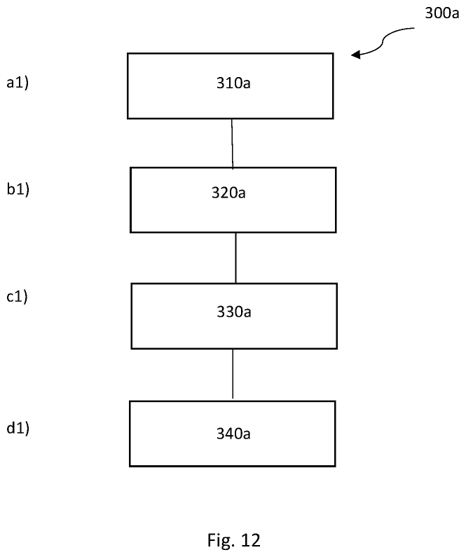

FIG. 12 shows a flow chart of a method 300a for predicting an industrial time dependent process.

In step 310a, i.e. step a1), currently measured data indicative of a current condition under which the industrial time dependent process currently takes place is received via an input channel. At least one key performance indicator (KPI) is provided for quantifying the industrial time dependent process.

In step 320a, i.e. step b1), at least one expected condition parameter indicative of a future condition under which the industrial time dependent process will take place within a prediction horizon is received via the input channel.

In step 330a, i.e. step c1), a predictive data-driven model is applied by a processor to an input dataset comprising the currently measured data and the at least one expected condition parameter to estimate a future value of the at least one KPI within the prediction horizon. The predictive data-driven model is parametrized or trained according to a training dataset comprising historical data of the at least one condition parameter and the at least one KPI and synthetic samples of the at least one condition parameter and the at least one KPI, which are optionally provided by a method as described above.

In step 340a, i.e. step d1), a prediction of the future value of at least one KPI within the prediction horizon which is usable for monitoring and/or controlling the industrial time dependent process is provided via an output channel.

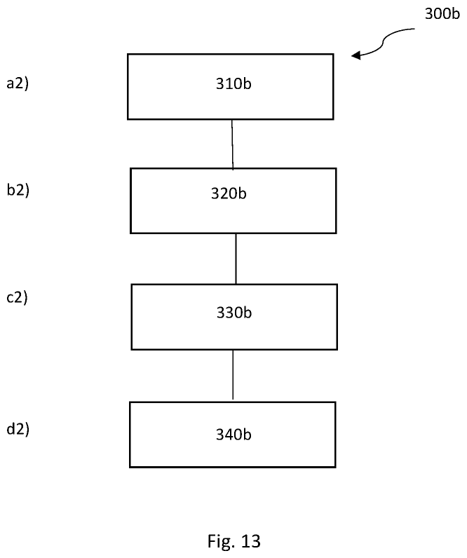

FIG. 13 shows a flow chart of a method 300b for predicting an industrial time dependent process.

In step 310b, i.e. step a2), previously measured data indicative of a past condition under which the industrial time dependent process took place is received via an input channel. At least one key performance indicator (KPI) is provided for quantifying the industrial time dependent process.

In step 320b, i.e. step b2), at least one condition parameter indicative of a current condition under which the industrial time dependent process currently takes place is received via the input channel.

In step 330b, i.e. step c2), a predictive data-driven model is applied by a processor to an input dataset comprising the previously measured data and the at least one condition parameter to estimate a current value of the at least one KPI. The predictive data-driven model is parametrized or trained according to a training dataset comprising historical data of the at least one condition parameter the at least one KPI and synthetic samples of the at least one condition parameter and the at least one KPI, which are optionally provided by a method according to a method as described above.

In step 340b, i.e. step d2), a prediction of the current value of at least one KPI is provided via the output channel which is usable for monitoring and/or controlling the industrial time dependent process.

It will be appreciated that the above operation may be performed in any suitable order, e.g., consecutively, simultaneously, or a combination thereof, subject to, where applicable, a particular order being necessitated, e.g., by input/output relations.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

### REFERENCES

Junyoung Chung, Kyle Kastner, Laurent Dinh, KratarthGoel, Aaron C Courville, and Yoshua Bengio. A recurrent latent variable model for sequential data. In Advances inneural information processing systems, pages 2980-2988, 2015.
Mike Wu and Noah Goodman. Multimodal generative models for scalable weakly-supervised learning. In Advances in Neural Information Processing Systems, pages 5575-5585, 2018.

1. A device for generating synthetic samples for expanding a training dataset of a predictive data-driven model for predicting an industrial time dependent process, comprising:
an input unit;
a processing unit; and
an output unit;
wherein the input unit is configured to receive historical data of at least one condition parameter indicative of a condition under which the industrial time dependent process took place and at least one KPI provided for quantifying the industrial time dependent process;
wherein the processing unit is configured to apply a data-driven generative model to derive synthetic samples of the at least one condition parameter and the at least one KPI from the historical data, wherein the data-driven generative model is parametrized or trained based on a training dataset comprising real-data examples of the at least one condition parameter and the at least one KPI; and
wherein the output unit is configured to provide the synthetic samples to the training dataset of the predictive data-driven model.

2. The device according to claim 1,
wherein the synthetic samples comprise a synthetic sequence representative of a time series of the at least one condition parameter and the at least one KPI.

3. The device according to claim 2,
wherein the data-driven generative model comprises an RNN-MVAE model with the at least one condition parameter and the at least one KPI as input and a synthetic sequence of the at least one condition parameter and the at least one KPI as output;
wherein the RNN-MVAE model comprises a multimodal variational autoencoder, MVAE;
wherein the MVAE comprises two recurrent neural networks, RNNs, that act as an encoder-decoder pair for the at least one condition parameter; and
wherein the MVAE comprises two RNNs that act as an encoder-decoder pair for the at least one KPI.

4. The device according to claim 2,
wherein the data-driven generative model comprises a Seq-MVAE model with the at least one condition parameter and the at least one KPI as an initial input and a synthetic sample of the at least one condition parameter and the at least one KPI as output;
wherein the Seq-MVAE model comprises a multimodal variational autoencoder, MVAE;
wherein the MVAE comprises two feed forward neural networks, FFNNs, that act as an encoder-decoder pair for the at least one condition parameter;
wherein the MVAE comprises two feed forward neural networks, FFNNs, that act as an encoder-decoder pair for the at least one KPI;
wherein each decoder and encoder are coupled to a respective recurrent neural network, RNN; and
wherein for each point in time the output of the Seq-MVAE is aggregated into a vector representative of the synthetic sequence.

5. The device according to claim 3, wherein the RNN comprises at least one of:
an echo state network, ESN;
a gated recurrent unit, GRU, network
an ordinary differential equation, ODE, network; and
a long short-term memory, LSTM, network.

6. An apparatus for predicting an industrial time dependent process, comprising:
an input unit;
a processing unit; and
an output unit;
wherein the input unit is configured to receive currently measured data indicative of a current condition under which the industrial time dependent process currently takes place, wherein at least one key performance indicator, KPI, is provided for quantifying the industrial time dependent process;
wherein the input unit is configured to receive at least one expected condition parameter indicative of a future condition under which the industrial time dependent process will take place within a prediction horizon;
wherein the processing unit is configured to apply a predictive data-driven model to an input dataset comprising the currently measured data and the at least one expected condition parameter to estimate a future value of the at least one KPI within the prediction horizon, wherein the predictive data-driven model is parametrized or trained according to a training dataset comprising historical data of the at least one condition parameter and the at least one KPI and synthetic samples of the at least one condition parameter and the at least one KPI; and
wherein the output unit is configured to provide a prediction of the future value of at least one KPI within the prediction horizon which is usable for monitoring and/or controlling the industrial time dependent process.

7. An apparatus for predicting an industrial time dependent process, comprising:
an input unit;
a processing unit; and
an output unit;
wherein the input unit is configured to receive previously measured data indicative of a past condition under which the industrial time dependent process took place, wherein at least one key performance indicator, KPI, is provided for quantifying the industrial time dependent process;
wherein the input unit is configured to receive at least one condition parameter indicative of a current condition under which the industrial time dependent process currently takes place;
wherein the processing unit is configured to apply a predictive data-driven model to an input dataset comprising the previously measured data and the at least one condition parameter to estimate a current value of the at least one KPI, wherein the predictive data-driven model is parametrized or trained according to a training dataset comprising historical data of the at least one condition parameter the at least one KPI and synthetic samples of the at least one condition parameter and the at least one KPI; and
wherein the output unit is configured to provide a prediction of the current value of at least one KPI which is usable for monitoring and/or controlling the industrial time dependent process.

8. A method for generating synthetic samples for expanding a training dataset of a predictive data-driven model for predicting an industrial time dependent process, comprising:
a) receiving, via an input channel, historical data of at least one condition parameter indicative of a condition under which the industrial time dependent process took place and at least one KPI provided for quantifying the industrial time dependent process;
b) applying, via a processor, a data-driven generative model to generate synthetic samples of the at least one condition parameter and the at least one KPI from the historical data, wherein the data-driven generative model is parametrized or trained based on a training dataset comprising real-data examples of the at least one condition parameter and the at least one KPI; and
c) providing, via an output channel, the synthetic samples to the training dataset of the predictive data-driven model.

9. The method according to claim 8,
wherein the synthetic samples comprise a synthetic sequence representative of a time series of the at least one condition parameter and the at least one KPI.

10. The method according to claim 9,
wherein the data-driven generative model comprises an RNN-MVAE model with the at least one condition parameter and the at least one KPI as input and a synthetic sequence of the at least one condition parameter and the at least one KPI as output;
wherein the RNN-MVAE model comprises a multimodal variational autoencoder, MVAE;
wherein the MVAE comprises two recurrent neural networks, RNNs, that act as an encoder-decoder pair for the at least one condition parameter; and
wherein the MVAE comprises two RNNs that act as an encoder-decoder pair for the at least one KPI.

11. The method according to claim 9,
wherein the data-driven generative model comprises a Seq-MVAE model with the at least one condition parameter and the at least one KPI as an initial input and a synthetic sample of the at least one condition parameter and the at least one KPI as output;
wherein the Seq-MVAE model comprises a multimodal variational autoencoder, MVAE;
wherein the MVAE comprises two feed forward neural networks, FFNNs, that act as an encoder-decoder pair for the at least one condition parameter;
wherein the MVAE comprises two feed forward neural networks, FFNNs, that act as an encoder-decoder pair for the at least one KPI;
wherein each decoder and encoder is coupled to a respective recurrent neural network, RNN; and
wherein for each point in time the output of the Seq-MVAE is aggregated into a vector representative of the synthetic sequence.

12. A method for predicting an industrial time dependent process, comprising:
a1) receiving, via an input channel, currently measured data indicative of a current condition under which the industrial time dependent process currently takes place, wherein at least one key performance indicator, KPI, is provided for quantifying the industrial time dependent process;
b1) receiving, via the input channel, at least one expected condition parameter indicative of a future condition under which the industrial time dependent process will take place within a prediction horizon;
c1) applying, via a processor, a predictive data-driven model to an input dataset comprising the currently measured data and the at least one expected condition parameter to estimate a future value of the at least one KPI within the prediction horizon, wherein the predictive data-driven model is parametrized or trained according to a training dataset comprising historical data of the at least one condition parameter and the at least one KPI and synthetic samples of the at least one condition parameter and the at least one KPI; and
d1) providing, via an output channel, a prediction of the future value of at least one KPI within the prediction horizon which is usable for monitoring and/or controlling the industrial time dependent process.

13. A method for predicting an industrial time dependent process, comprising:
a2) receiving, via an input channel, previously measured data indicative of a past condition under which the industrial time dependent process took place, wherein at least one key performance indicator, KPI, is provided for quantifying the industrial time dependent process;
b2) receiving, via the input channel, at least one condition parameter indicative of a current condition under which the industrial time dependent process currently takes place;
c2) applying, via a processor, a predictive data-driven model to an input dataset comprising the previously measured data and the at least one condition parameter to estimate a current value of the at least one KPI, wherein the predictive data-driven model is parametrized or trained according to a training dataset comprising historical data of the at least one condition parameter the at least one KPI and synthetic samples of the at least one condition parameter and the at least one KPI; and
d2) providing, via an output channel, a prediction of the current value of at least one KPI which is usable for monitoring and/or controlling the industrial time dependent process.

14. A computer program product comprising a computer program with program code for performing a method according to claim 8.

15. (canceled)
